(19) United States
(12) Patent Application Publication
(10) Pub. No.: US 2016/0279846 A1
(43) Pub. Date: Sep. 29, 2016

(54) APPARATUS AND METHOD FOR PRODUCING RESIN PRODUCTS

(71) Applicants: Hyundai Motor Company, Seoul (KR); Kia Motors Corporation, Seoul (KR)

(72) Inventors: Byung Seok KONG, Gunpo-si (KR); Jong Sik BAE, Suwon-si (KR); Hee Jun JEONG, Hwaseong-si (KR)

(73) Assignees: Hyundai Motor Company, Seoul (KR); Kia Motors Corporation, Seoul (KR)

(21) Appl. No.: 14/931,014

(22) Filed: Nov. 3, 2015

(30) Foreign Application Priority Data
Mar. 25, 2015 (KR) 10-2015-0041175

(51) Int. Cl. B29C 45/16; B29C 45/73; B29C 44/02; B29C 45/22

(52) U.S. Cl. CPC B29C 45/164; B29C 45/22; B29C 45/7312; B29C 44/02; B29K 2105/04

(57) ABSTRACT

An apparatus for two-shot forming to form a plate shape resin product may include a first mold, a second mold, and an injection machine for injecting a raw resin including a foaming agent into a cavity defined by the first mold and the second mold through gates of the second mold, in which the first mold that is brought in contact with the outer side of a formed resin product is equipped with a cooling device for partially and intensively cooling a thick portion of the resin product in the first mold that is brought in contact with a relatively thick portion of a part rapidly changing in thickness in the resin product.

### CROSS-REFERENCE TO RELATED APPLICATION

This application claims priority to Korean Patent Application No. 10-2015-0041175 filed Mar. 25, 2015, the entire contents of which is incorporated herein for all purposes by this reference.

### BACKGROUND OF THE INVENTION

1. Field of the Invention

The present disclosure relates to an apparatus and a method for producing a resin product. More particularly, it relates to an apparatus and a method for producing a resin product which can minimize contracting and bending due to differences in cooling rate of parts of a product after injection molding and can prevent a defect of an external appearance due to contracting and bending.

2. Description of Related Art

In general, a crash pad is disposed at the front around which there are a steering wheel and an instrument inside a vehicle to provide a neat environment for passengers.

In the related art, crash pads were manufactured by performing injection molding on one kind of synthetic resin, and thereafter, as an airbag has been provided for the passenger seat in a vehicle, a Passenger-side AirBag (PAB) Door has been formed to be separated by a separation line formed by a laser around the portion of a crash pad where the passenger-side air bag is positioned.

Recently, a crash pad that allows a PAB door to more easily open when an airbag expands has been manufactured by making a section around an airbag, that is, a PAB door section including a separation line and a chute, using a very soft material in two-shot molding that simultaneously injects two kinds of resin into a mold.

The separation line allows a PAB door to be separated from a crash pad body by expansion of an airbag cushion and the chute is a part where an airbag housing keeping a folded airbag cushion is installed to mount an airbag.

In general, PolyPropylene Fiber (PPF) resin having a high rigidity is used as first resin for the body of a crash pad and ThermoPlastic Olefin (TPO) or ThermoPlastic Elastomer (TPE) resin having high ductility is used as second resin for a PAB door section.

In the prior art, there has been disclosed a technology for making a PAB door section of second resin having high ductility, integrally making the body of a crash pad except for the PAB door section of first resin using two-shot molding, and preventing mix of the first resin and the second resin.

A method of forming an airbag door separation line using an in-mold blade on a crash pad has been disclosed in prior art.

A technology of improving a difference of a foam thickness by manufacturing a crash pad with a resin layer and spraying foam to the resin layer through a spray gate with a plurality of nozzles has been disclosed in prior art.

Meanwhile, as a method of forming a separation line of an airbag door (PAB door), there has been known a method of a separation line through post-processing such as milling or laser processing after forming, a method simply using in-mold forming, a gas injection method of forming a thin separation line by injecting a gas along the separation line, a method of forming a separation line using an in-mold blade, and the like.

In those prior art methods, the method of forming a separation line through post-processing requires equipment for the post-processing, so it is disadvantageous in manufacturing cost, and as for the gas injection method, it is difficult to control the path of an injected gas.

According to the method using an in-mold blade, it is difficult to control the thickness of the separation line (the redundant in cutting), and according to the method simply using in-mold forming, it is advantageous in manufacturing cost, but a product locally contracts and bends due to a rapid change in thickness such as at the separation line and the chute.

Herein, the method simply using in-mold forming and the problems are described hereafter in detail with reference to FIG. 1, FIG. 2A and FIG. 2B.

As illustrated in FIG. 1, a soft sheet or foil type of skin 110 is inserted in molds 100 and 200 and first resin 230 and second resin 240 are injected and two-shot at low pressure in the molds through distribution gates 210 and a center gate 220 at predetermined positions in the mold 200 so that an airbag door part and the other part of a crash pad (hereafter, referred to as ‘crash pad body’) are integrally formed by the second resin 240 and the first resin 230, respectively.

FIG. 2A and FIG. 2B are cross-sectional views illustrating a crash pad 10 including an airbag door section 130. In this case, when the method simply using in-mold forming is applied, it is possible to reduce the manufacturing cost and stably form a product, but there is a difference in thickness due to a separation line 140 and a chute 150, so the cooling rates are different at parts in cooling after injection.

Accordingly, the airbag door section 130 partially contracts and bends accordingly due to the difference in cooling rate and the bending deteriorates the external appearance.

The portion that is thick and slowly cools of the portions that rapidly change in thickness contracts relatively much and the contracting portion is recessed on the outer surface, thereby bending on the outer side.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for producing a resin product that can minimize contracting and bending due to differences in cooling rate of parts of a product after injection molding and can prevent a defect of an external appearance due to contracting and bending.

According to various aspects of the present invention, an apparatus for two-shot forming to form a plate shape resin product may include a first mold a second mold, and an injection machine for injecting a raw resin including a foaming agent into a cavity defined by the first mold and the second mold through gates of the second mold, in which the first mold that is brought in contact with the outer side of a formed resin product may be equipped with a cooling device for partially and intensively cooling a thick portion of the resin product in the first mold that is brought in contact with a relatively thick portion of a part rapidly changing in thickness in the resin product.

The cooling device may include a partial cooling channel achieved by forming a passage for a coolant for cooling injected resin in the first mold.

The plate shape resin product may include a crash pad formed by integrating an airbag door section including a separation line and a chute with a crash pad body.

The cooling device may be positioned at portions of the first mold that are brought in contact with both sides around the separation line of the airbag door section and the chute in the airbag door section.

According to various aspects of the present invention, a method of producing a plate shape resin product using two-shot forming may include injecting a first resin and a second resin including a foaming agent from injection machines into a cavity defined by a first mold and a second mold through gates of the second mold such that foamed cells in a product expand in forming, and partially and intensively cooling, in cooling water, a relatively thick portion of a part rapidly changing in thickness of a resin product after injection by a cooling device of the first mold that is brought in contact with an outer side of the formed resin product so that formed cells of the intensively cooled thick portion of the resin product are larger in size than other portions of the resin product.

The plate shape resin product that is formed by two-shot forming may include a crash pad formed by integrating an airbag door section including a separation line and a chute with a crash pad body.

A crash pad may be manufactured by in-mold two-shot molding that includes injecting a first resin and a second resin after inserting a skin into molds.

The first resin may include PolyPropylene Fiber (PPF) resin for forming a crash pad body.

The second resin may include ThermoPlastic Olefin (TPO) resin for forming an airbag door section.

Therefore, according to the apparatus and the method for producing a resin product of the present invention, since the contraction-possible portion is intensively cooled in an earlier stage by expansion of the foamed cell, it is possible to effectively prevent partial contraction and bending of the outer side of a product, so it is possible to improve the problem with the external appearance of the product.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a method simply using in-mold forming of the related art.

FIG. 2A and FIG. 2B are views illustrating problems in simply in-mold forming of the related art.

FIG. 3 is a view illustrating an exemplary method of producing a resin product according to the present invention.

FIG. 4A and FIG. 4B are cross-sectional views illustrating a resin product manufactured in accordance with the present invention.

FIG. 5 is a view illustrating the state of a hole in a foamed cell in resin in a process of producing a resin product in accordance with the present invention.

FIG. 6 is a view illustrating the sizes of foamed cells at intensive cooling portion and other portions in the present invention.

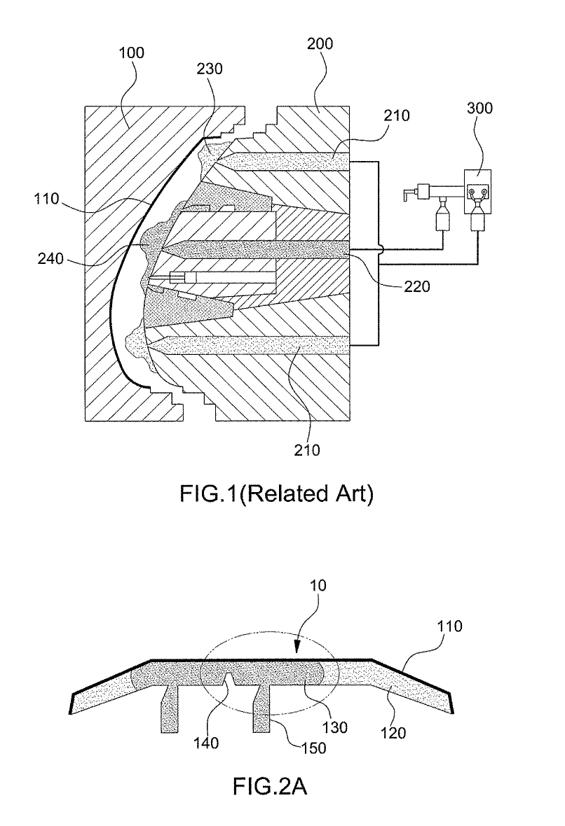

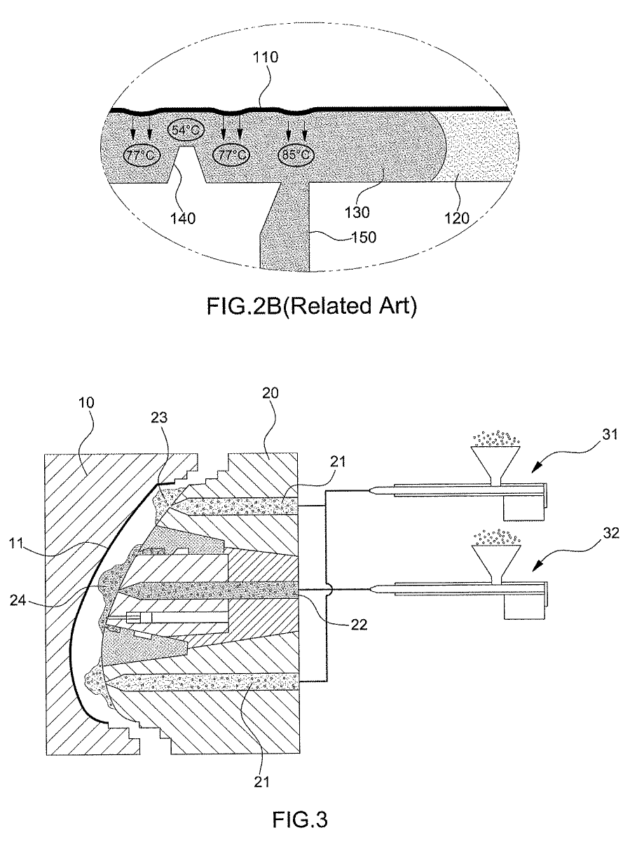

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention provides a method for producing a resin product that can minimize contracting and bending due to differences in cooling rate of parts of a product after injection molding and can prevent a defect of an external appearance due to contracting and bending.

In particular, the present invention provides a method of producing a crash pad that can improve problems with contracting and bending, which is caused by differences in cooling rate of parts due to rapid changes in thickness at a separation line and a chute in a process of manufacturing a crash pad including an airbag door section having the separation line and the chute using in-mold two-shot, and a defect of an external appearance of a product due to the contracting and bending.

In the present invention, a resin product may be a plate shape product, particularly, a crash pad 1 including a crash pad body 12 and an airbag door section 13 which are integrally formed, as described above, and the portions rapidly changing in thickness in the airbag door section 13 of the crash pad 1 may be a separation line 14 and a chute 15.

The portions that contract and bend in a product manufactured by in-mold two-shot of the related art are a portion around a separation line that is adjacent to the separation line, and thicker and cooled slowly than the separation line, and a chute adjacent to the other portion of the airbag door section.

In the following description, it is assumed that a crash pad 1 is a resin product and a separation line 14 and a chute 15 rapidly change in thickness.

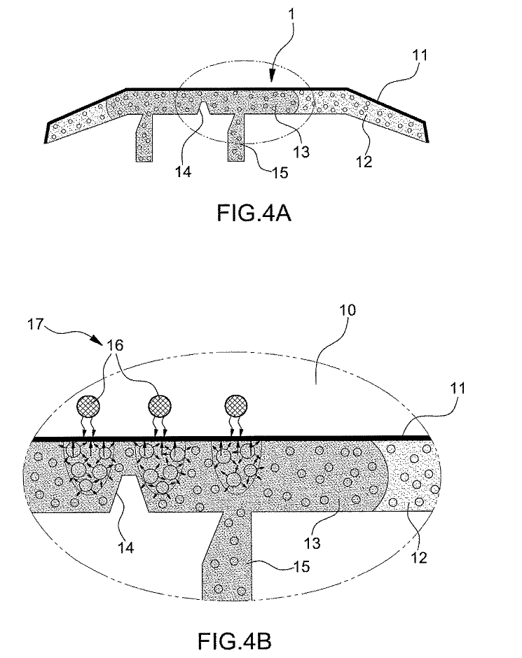

FIG. 3 is a view illustrating a method of producing a resin product according to the present invention and FIG. 4A and FIG. 4B are cross-sectional views illustrating a resin product manufactured in accordance with the present invention.

Referring to FIG. 3, an apparatus for two-shot forming that forms a product includes a first mold 10, a second mold 20, and injection machines 31 and 32 that inject raw resins 23 and 24 including a foaming agent into a cavity in the molds through gates 21 and 22 in the second mold 20.

Herein, the injection machines include a first injection machine 31 for forming a crash pad body that is the other except for an airbag door section 13 and a second injection machine 32 for forming the airbag door section 13.

The first injection machine 31 can inject the liquid-state first resin 23 including a foaming agent as a raw resin for forming the crash pad body 12 through the distribution gate 21 at predetermined position in the second mold 20 and the second injection machine 32 can inject a liquid-state second resin 24 including a foaming agent as a raw material for forming the airbag door section 13 through the center gate 22 of the second mold 20.

The first mold 10 that is brought in contact with the outer side of a crash pad 1 that is a product is equipped with a cooling device 17 for partially and intensively cooling in an early stage a portion around a separation line 14 of the airbag door section 13 and a chute 15, that is, contraction-possible portions that contracted in the manufacturing process in the related art.

In various embodiments, the cooling device 17 may be a partial cooling channel 16 achieved by forming a passage for a coolant for cooling injected resin in the first mold 10, in which the coolant may be water, that is, cooling water.

The portion where the partial cooling channel 16 is formed is the portion of the first mold 10 that is brought in contact with the contraction-possible portion, in detail, the portion of the mold that is brought in contact with a relatively thick portion (that is, contraction-possible portion) in the part rapidly changing in thickness of a product, and the partial cooling channel is positioned to be able to partially and intensively cool the thick portion of the part rapidly changing in thickness, using the cooling water flowing therein.

In more detail, the partial cooling channel 16 is formed at portions of the mold that are brought in contact with both sides around the separation line 14 of the airbag door section 13 and the chute 15 in the airbag door section 13.

A process of manufacturing a resin product, that is, a crash pad 1 using the apparatus for two-shot forming is described hereafter.

The soft sheet or foil type of skin 11 is inserted into the molds 10 and 20 to be in contact with the inside of the cavity of the first mold 10.

A resin raw material and a chemical foaming agent for the crash pad body 12 are put into the first injection machine 31 and a resin raw material and a chemical foaming agent for the airbag door section 13 are put into the second injection machine 32.

Then, with the molds 10 and 20 closed, the liquid-stage first resin 23 including a foaming agent as a raw resin for the crash pad body 12 is injected from the first injection machine 31 into the distribution gates 21 of the second mold 20, and the liquid-stage second resin 24 including a foaming agent as a raw resin for the airbag door section 13 is injected from the second injection machine 32 into the center gate 22 of the second mold 20.

Accordingly, the raw resin is injected into the cavities in the molds 10 and 20 through the distribution gates 21 and the center gate 22, so the crash pad 1 including the crash pad body 12 and the airbag door section 13 that are integrated is formed.

In the manufacturing of a crash pad product, the raw resin for forming the crash pad body 12 may be PPF resin including a foaming agent and the raw resin for forming the airbag door section 13 may be TPO resin including a foaming agent.

In the process of forming a product, cooling water is supplied through the partial cooling channel 16 of the first mold 10 so that the contraction-possible portion of the product can be intensively cooled in an earlier stage after the resin is injected.

Accordingly, during forming after the resin is injected, contraction is primarily prevented by expansion of foamed cells in the molds, and secondarily, the foamed cells at the contraction-possible portion are larger than those at other portions due to intensive cooling by the cooling water in the partial cooling channel 16.

Therefore, by the intensive cooling in an earlier stage, it is possible to keep foamed cells at the contraction-possible portion larger than those at other portions, so it is possible to further maximize the effect of preventing contraction by foaming expansion.

FIG. 5 is a view illustrating the state of a hole in a foamed cell in resin in a process of producing a resin product in accordance with the present invention. Referring to FIG. 5, a foamed cell in a resin is expanded in forming by the foaming agent in the resin before forming, and in solidifying after forming; the foamed cell of the resin a little contracts in comparison to the maximum expansion state.

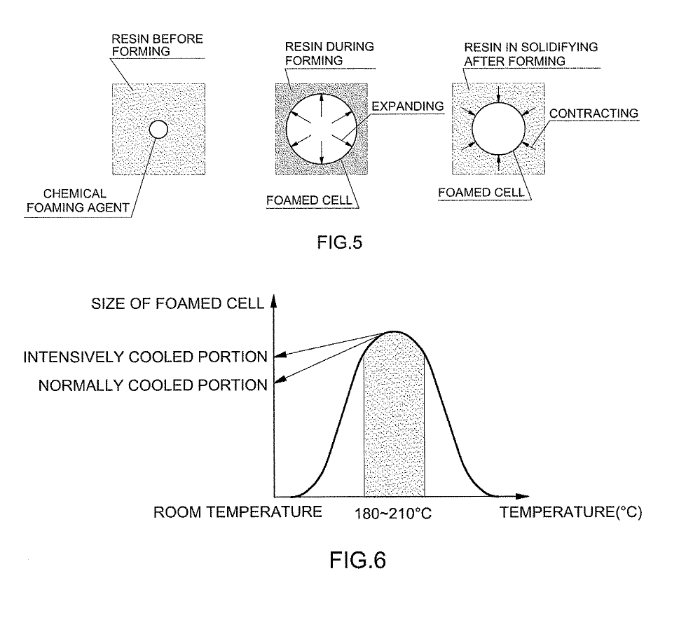

FIG. 6 is a view illustrating the sizes of foamed cells at intensive cooling portion and other portions in the present invention. Referring to FIG. 6, during forming, the resin increases in temperature, the size of the foamed cell increases to the maximum, and then the size of the foamed cell a little decreases by cooling.

At the portion intensively cooled by the partial cooling channel 16, the foamed cell remains larger than the other portion that has been cooled normally. Accordingly, the size of the foamed cell remains large at the intensive cooled portion and contraction and deformation at the contraction-possible portion can be prevented.

Therefore, in the present invention, since the contraction-possible portion is intensively cooled in an earlier stage by expansion of the foamed cell, it is possible to effectively prevent partial contraction and bending of the outer side of a product, so it is possible to improve the problem with the external appearance of the product.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. An apparatus for two-shot forming to form a plate shape resin product, the apparatus comprising:
a first mold;
a second mold; and
an injection machine for injecting a raw resin including a foaming agent into a cavity defined by the first mold and the second mold through gates of the second mold,
wherein the first mold that is brought in contact with the outer side of a formed resin product is equipped with a cooling device for partially and intensively cooling a thick portion of the resin product in the first mold that is brought in contact with a relatively thick portion of a part rapidly changing in thickness in the resin product.

2. The apparatus of claim 1, wherein the cooling device comprises a partial cooling channel achieved by forming a passage for a coolant for cooling injected resin in the first mold.

3. The apparatus of claim 1, wherein the plate shape resin product comprises a crash pad formed by integrating an airbag door section including a separation line and a chute with a crash pad body.

4. The apparatus of claim 3, wherein the cooling device is positioned at portions of the first mold that are brought in contact with both sides around the separation line of the airbag door section and the chute in the airbag door section.

5. A method of producing a plate shape resin product using two-shot forming, comprising:
injecting a first resin and a second resin including a foaming agent from injection machines into a cavity defined by a first mold and a second mold through gates of the second mold such that foamed cells in a product expand in forming; and
partially and intensively cooling, in cooling water, a relatively thick portion of a part rapidly changing in thickness of a resin product after injection by a cooling device of the first mold that is brought in contact with an outer side of the formed resin product so that formed cells of the intensively cooled thick portion of the resin product are larger in size than other portions of the resin product.

6. The method of claim 5, wherein the cooling device comprises a partial cooling channel achieved by forming a passage for a coolant for cooling injected resin in the first mold.

7. The method of claim 5, wherein the plate shape resin product that is formed by two-shot forming comprises a crash pad formed by integrating an airbag door section including a separation line and a chute with a crash pad body.

8. The method of claim 7, wherein the cooling device is positioned at portions of the first mold that are brought in contact with both sides around the separation line of the airbag door section and the chute in the airbag door section.

9. The method of claim 7, wherein a crash pad is manufactured by in-mold two-shot molding that includes injecting a first resin and a second resin after inserting a skin into molds.

10. The method of claim 7, wherein the first resin comprises PolyPropylene Fiber (PPF) resin for forming a crash pad body.

11. The method of claim 7, wherein the second resin comprises ThermoPlastic Olefin (TPO) resin for forming an airbag door section.
